(19) United States
(12) Patent Application Publication
(10) Pub. No.: US 2025/0314125 A1
(43) Pub. Date: Oct. 9, 2025

(54) CORD WINDING DEVICE OF A CURTAIN

(71) Applicant: Guangdong Leafy Windoware Co., Ltd., Huizhou (CN)

(72) Inventors: Zhenbang LEI, Huizhou (CN); Xingbang LEI, Huizhou (CN)

(21) Appl. No.: 19/083,147

(22) Filed: Mar. 18, 2025

(30) Foreign Application Priority Data
Apr. 8, 2024 (CN) 202420707089.4

(51) Int. Cl. E06B 9/322

(52) U.S. Cl. CPC E06B 9/322

(57) ABSTRACT

A cord winding device of a curtain includes a base forming one end wall, a reel mounted to the base and defining an inner hole for a transmission shaft extending through, and an external threaded tube fixed to the end wall and coaxially arranged with the reel for the transmission shaft extending through. A connection structure is provided in the inner hole, which connects the reel and the transmission shaft in a relatively fixed manner in a circumferential direction and in a relatively movable manner in an axial direction. An internal thread is provided in the inner hole. One end of the external threaded tube is inserted into the inner hole and screwed with the internal thread. When the reel rotates with the transmission shaft, the reel moves axially relative to the external threaded tube by spiraling and keeps being always screwed to the external threaded tube.

### FIELD OF THE PRESENT INVENTION

The present invention relates to the technical field of curtain accessories and, more particularly to a cord winding device of a curtain.

### BACKGROUND OF THE PRESENT INVENTION

A cord winding device of a curtain is usually installed in an upper beam of the curtain, which is used to wind or unwind a carry cord connected to a curtain body at the other end under a corresponding driving device to achieve the lifting or lowering of the curtain body.

A current cord winding device includes a base and a cord winding drum rotatably mounted on the base. The cord winding drum includes a cord winding section for a carrying cord being wound thereon and a screw section coaxially connected to one end of the cord winding section. A nut is fixedly mounted on the base and screwed to the screw section. A transmission shaft of a driving device extends through an axis center of the cord winding drum and is relatively fixed to the cord winding drum in the circumferential direction, so as to drive the cord winding drum to rotate to achieve the winding or unwinding of the carrying cord. When the cord winding drum rotates, the screw section rotates relative to the nut, which drives the cord winding drum to move axially relative to the base, and achieves the sequential winding of the carrying cord relative to the winding section at a fixed position, avoiding the entanglement or looseness of the carrying cord.

However, in the specific implementation process, due to the coaxial connection between the cord winding section and the screw section of the cord winding drum, when the cord winding drum moves axially away from the cord winding section, the screw section will extend out from a corresponding end of the base, and thus, a sufficient space needs to be reserved inside or outside the corresponding end of the base to avoid the screw section, resulting in a relatively large installation size of the cord winding device as a whole in the axial direction (including the size of the device itself and the size of the avoidance space that needs to be reserved), which is not conducive to the miniaturization of the cord winding device. Moreover, in order to reduce the material used for the base, the screw section is usually extended to the outside of the base. At this time, the screw section is also susceptible to interference from other components outside the base or foreign objects accidentally entering the upper beam of the curtain, which can affect the normal lifting or lowering of the curtain body.

### SUMMARY OF THE INVENTION

### Technical Problem

Therefore, the technical problem to be solved by the embodiments of the present invention is to provide a cord winding device of a curtain, which can effectively reduce an axial installation size of the device.

### Solutions to the Problem

To solve the above-mentioned technical problems, an embodiment of the present invention provides the following solutions. A cord winding device of a curtain includes a base forming one end wall on at least one end, a reel mounted to the base and defining an inner hole extending through the reel in an axis center of the reel for a transmission shaft of the curtain extending through, and an external threaded tube fixed to the end wall of the base with one end and coaxially arranged with the reel for the transmission shaft extending through an axial hole of the external threaded tube; a connection structure is provided in and at one end of the inner hole, which connects the reel and the transmission shaft in a relatively fixed manner in a circumferential direction and in a relatively movable manner in an axial direction; an internal thread is provided on the other end of the inner hole away from the connection structure, one end of the external threaded tube is inserted into the inner hole from the end of the inner hole with the internal thread and screwed correspondingly with the internal thread; when the reel rotates with the transmission shaft, the reel moves axially relative to the external threaded tube by spiraling and keeps being always screwed to the external threaded tube.

Furthermore, a nut with the internal thread is fixedly assembled inside the inner hole, and the external threaded tube is correspondingly screwed to the nut.

Furthermore, a plurality of elastic positioning tabs extending along an axial direction is formed on an outer wall of the nut, and a distal end of each positioning tab is provided with an outwardly protruding positioning protrusion; a wall of the inner hole at the corresponding end defines a plurality of positioning holes, and the nut is inserted into the inner hole and positioned by the plurality of positioning protrusions engaging in the plurality of positioning holes.

Furthermore, a plurality of guide slots extending along the axial direction is defined the outer wall of the nut, and a plurality of guide protrusions extending along the axial direction is protruded on the wall at the corresponding end of the inner hole; wherein when the nut is inserted into the inner hole, the plurality of guide protrusions is correspondingly inserted into the plurality of guide slots.

Furthermore, a plurality of guide protrusions extending along the axial direction is formed on the outer wall of the nut, the wall of the inner hole defines a plurality of guide slots extending along the axial direction from a hole opening; wherein when the nut is inserted into the inner hole, the plurality of guide protrusions is correspondingly inserted into the plurality of guide slots.

Furthermore, the connection structure is a plurality of protruded protrusions protruding from a wall of the inner hole and corresponding to a plurality of axial slots defined in an outer wall of the transmission shaft, or, the connection structure is a plurality of key slots defined in the wall of the inner hole, corresponding to a plurality of key bars axially extending on the outer wall of the transmission shaft.

Furthermore, the internal thread is directly integrally formed on a wall of the inner hole.

Furthermore, the base is provided with two end walls at both ends, and an axial movement stroke of the reel is between the two end walls.

Furthermore, a positioning flange is formed radially outward at the end of the external threaded tube away from the reel, an anti-detachment hook is formed at a side of the positioning flange; an insertion slot is defined in the end wall of the corresponding end of the base, and a hook hole is defined in a slot wall of the insertion slot, corresponding to the anti-detachment hook; wherein after inserting the positioning flange into the insertion slot, the anti-detachment hook is hooked into the hook hole.

Furthermore, the cord winding device further includes a cover covered on a top of the base; two ends of the cover extend towards the base with two first fasteners, and a contact block corresponding to the insertion slot; the two end walls of the base are provided with two second fasteners that correspond one-to-one with the first fasteners, the cover is fixed relative to the base by hooking and cooperating with the first fasteners and the second fasteners, and the positioning flange is abutted against and fixed by the contact block.

### Beneficial Effects of the Invention

By adopting the above technical solution, embodiments of the present invention have at least the following beneficial effects. The embodiments of the present invention provide the internal thread in the inner hole of the reel and an external thread tube on the base to be inserted into and correspondingly screwed to the inner hole. When the reel rotates with the transmission shaft to wind or unwind the carrying cord, it synchronously rotates relative to the external thread tube and moves axially, achieving the fixed-point orderly winding or unwinding of the carrying cord on the reel. Moreover, the reel and the external thread tube are always screwed together, ensuring that the rope winding drum will not detach from the external thread tube. This is equivalent to the reel and the external thread tube forming a two section telescopic sleeve structure, and its maximum axial dimension will still not be greater than the said sleeve. The sum of the lengths of the reel and the external threaded tube can effectively reduce the axial installation size of the device as a whole.

### BRIEF DESCRIPTION OF THE DRAWINGS

FIG. 1 is an assembled, isometric view of an embodiment of a cord winding device of a curtain, showing a cover being exploded.

FIG. 2 is an exploded, isometric view of the cord winding device, without the cover.

FIG. 3 is a cross-sectional view of the cord winding device of FIG. 1, taken along a central axis of a transmission shaft, and with the cover being assembled.

FIG. 4 is a cross-sectional view of the cord winding device, taken along a central axis of a positioning hole.

FIG. 5 is an assembled, isometric view of a reel and a screw of another embodiment of a cord winding device of a curtain.

### DETAILED DESCRIPTION OF THE PRESENT INVENTION

The present application will be further described in detail below with reference to the accompanying drawings and embodiments. It should be understood that the following illustrative embodiments and illustrations are only used to explain the present invention and are not intended to limit the present invention, and that the embodiments of the present invention and the features of the embodiments can be combined with each other without conflict.

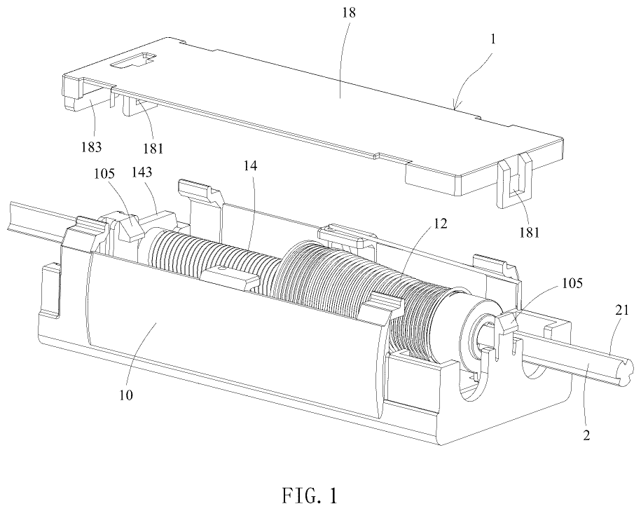

Referring to FIGS. 1-5, an embodiment of the present invention provides a cord winding device 1 of a curtain, including a base 10 forming one end wall on at least one end, and a reel 12 mounted to the base 10. The reel 12 defines an inner hole 121 extending through the reel 12 in an axis center of the reel 12, for a transmission shaft 2 of the curtain extending through. A connection structure 123 is provided in and at one end of the inner hole 121, which connects the reel 12 and the transmission shaft 2 in a relatively fixed manner in the circumferential direction and in a relatively movable manner in the axial direction. The cord winding device 1 further includes an external threaded tube 14 fixed to the end wall of the base 10 with one end, and coaxially arranged with the reel 12 for the transmission shaft 2 extending through an axial hole 141 of the external threaded tube 14. An internal thread 125 is also provided at the other end of the inner hole 121 away from the connection structure 123. The end of the external threaded tube 14 is inserted into the inner hole 121 from the end of the inner hole 121 with the internal thread 125 and screwed correspondingly with the internal thread 125. When the reel 12 rotates with the transmission shaft 2, it moves axially relative to the external threaded tube 14 by spiraling.

In the embodiment, the internal thread 125 is provided in the inner hole 121 of the reel 12, and the external thread tube 14 is additionally provided on the base 10 to be inserted into the inner hole 121 of the reel 12 and correspondingly screwed. When the reel 12 rotates with the transmission shaft 2 to wind or unwind a carrying cord 3, it synchronously rotates relative to the external thread tube 14 and moves axially, achieving the fixed-point orderly winding or unwinding of the carrying cord 3 on the reel 12. Moreover, the reel 12 and the external thread tube 14 are always screwed together, ensuring that the reel 12 will not detach from the external thread tube 14, which is equivalent to the reel 12 and the external thread tube 14 forming a two section telescopic sleeve structure, and its maximum axial dimension will still not exceed the sum of the lengths of the reel 12 and the external threaded tube 14, effectively reducing the overall axial installation size of the cord winding device 1.

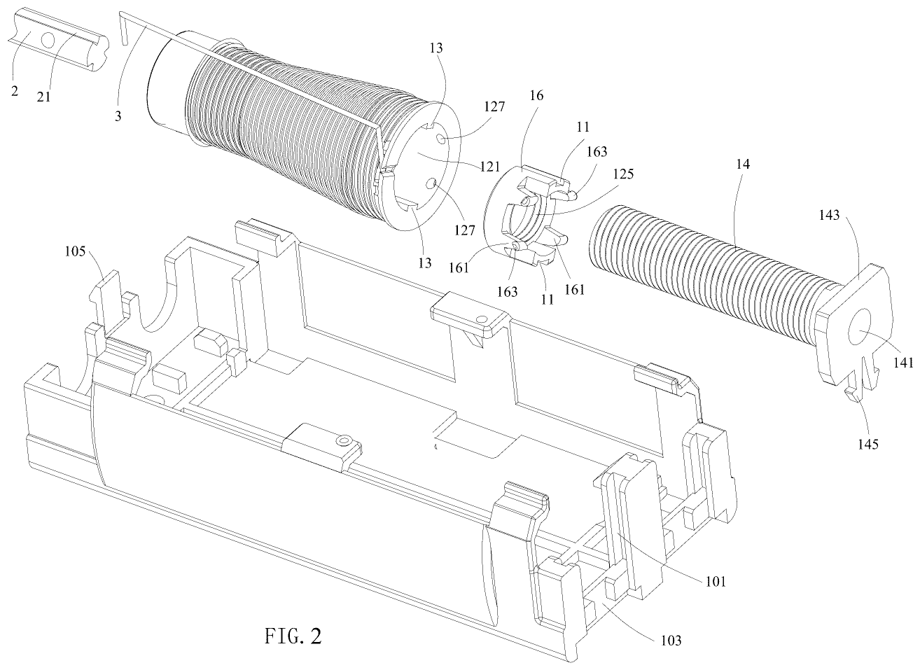

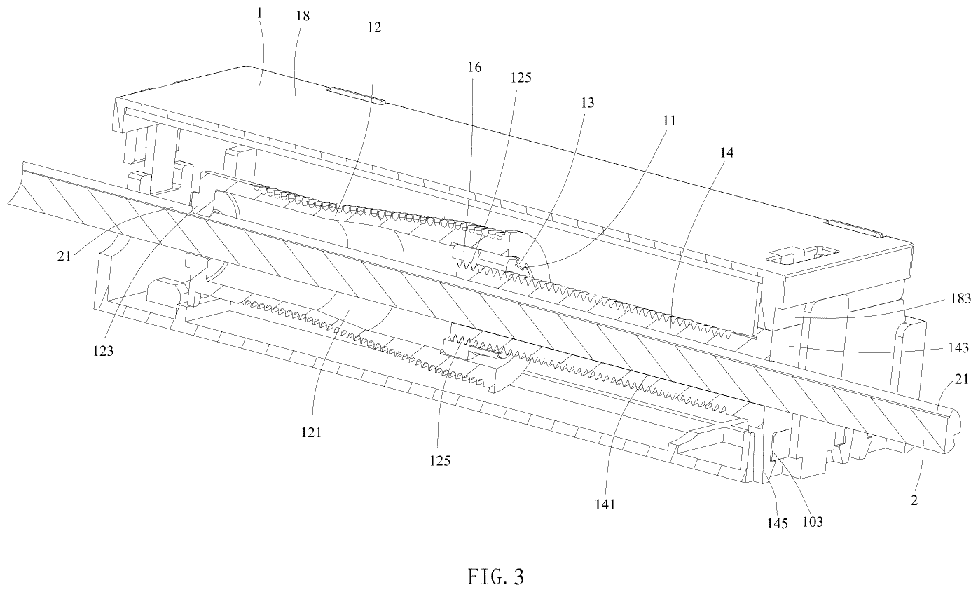

In an embodiment, as shown in FIGS. 2-3, a nut 16 with the internal thread 125 is fixedly assembled inside the inner hole 121, and the external threaded tube 14 is correspondingly screwed to the nut 16. In the embodiment, the nut 16 is fixed and assembled in the inner hole 121 of the reel 12, and the nut 16 is formed with the internal thread 125 corresponding to the threaded connection of the external threaded tube 14, which is more convenient for the processing and forming of the internal thread 125. At the same time, a corresponding standard nut 16 can also be used to reduce production costs.

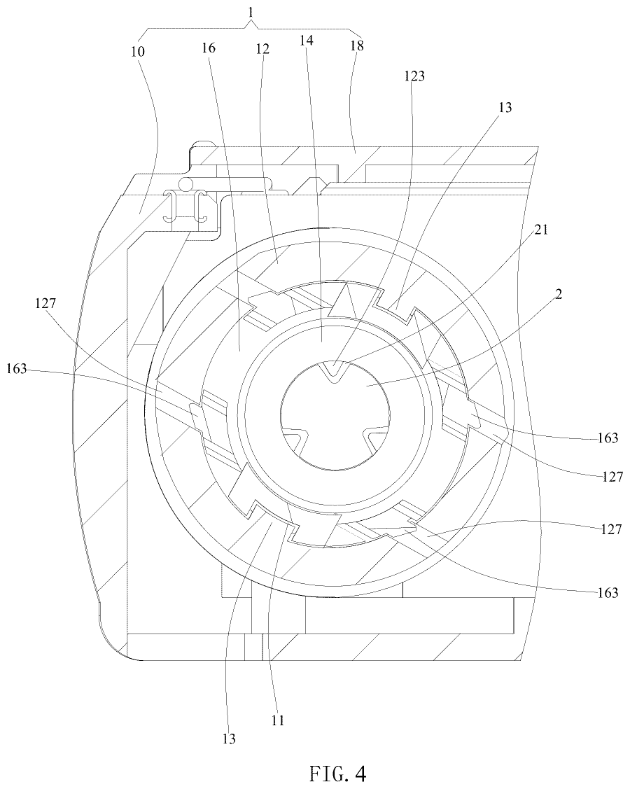

In an embodiment, as shown in FIGS. 2 and 4, a plurality of elastic positioning tabs 161 extending along the axial direction is formed on an outer wall of the nut 16, and a distal end of each positioning tab 161 is provided with an outwardly protruding positioning protrusion 163. A wall of the inner hole 121 at the corresponding end defines a plurality of positioning holes 127, and the nut 16 is inserted into the inner hole 121 and positioned by the positioning protrusions 163 engaging in the positioning holes 127. The embodiment forms the elastic positioning tabs 161 on the outer wall of the nut 16, which extend along the axial direction and have the outward protruding positioning protrusions 163 at the distal ends. When installing the nut 16, the positioning tabs 161 are elastically compressed radially and move inward into the inner hole 121 until the positioning protrusions 163 are engaged in the positioning holes 127 in the wall of the inner hole 121 of the reel 12, ensuring good connection stability. In the specific implementation process, the positioning tabs 161 can be symmetrically arranged, which has a better fixing effect on the nut 16.

In an embodiment, as shown in FIGS. 2-3, a plurality of guide slots 11 extending along the axial direction is defined the outer wall of the nut 16, and a plurality of guide protrusions 13 extending along the axial direction is protruded on the wall at the corresponding end of the inner hole 121. When the nut 16 is inserted into the inner hole 121, the guide protrusions 13 are correspondingly inserted into the guide slots 11. In the embodiment, the axially extending guide slots 11 are defined in the outer wall of the nut 16, and the guide protrusions 13 are formed by protruding from the wall at the corresponding end of the inner hole 121 along the axial direction. The nut 16 is positioned with the guide slots 11 aligning with the guide protrusions 13 to facilitate the assembly operation of the nut 16.

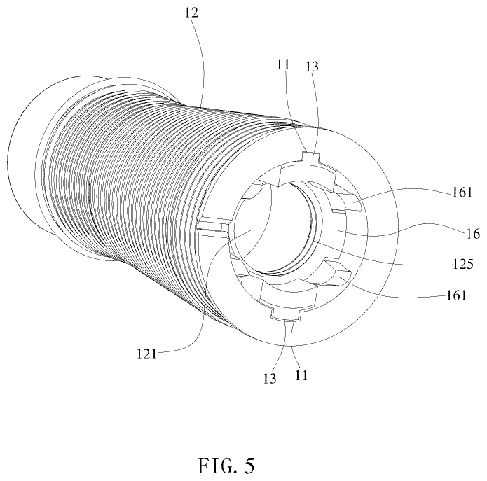

In an embodiment, as shown in FIG. 5, a plurality of guide protrusions 13 extending along the axial direction is formed on the outer wall of the nut 16. The wall of the inner hole 121 defines a plurality of guide slots 11 extending along the axial direction from the hole opening. When the nut 16 is inserted into the inner hole 121, the guide protrusions 13 are correspondingly inserted into the guide slots 11. In the embodiment, the guide protrusions 13 extending along the axial direction are formed on the outer wall of the nut 16 by convex molding. The wall at the corresponding end of the inner hole 121 defines the guide slots 11 extending along the axial direction from the hole opening. The nut 16 is positioned with the guide protrusions 13 aligning with the guide slots 11 at the installation position of the nut 16, and then pushed until the distal ends of the guide protrusions 13 are in contact with the bottom walls of the guide slots 11, which facilitates the positioning and installation of the nut 16.

In an embodiment, as shown in FIGS. 3-4, the connection structure 123 is a plurality of protruded protrusions 123 protruding from the wall of the inner hole 121 and corresponding to a plurality of axial slots 21 defined in the outer wall of the transmission shaft 2. Alternatively, the connection structure 123 is a plurality of key slots defined in the wall of the inner hole 121, corresponding to a plurality of key bars axially extending on the outer wall of the transmission shaft 2. In the embodiment, the axial slots 21 are fitted with the protruded protrusions 123 or the key bars are fitted with the key slots to achieve relative fixation of the reel 12 and the transmission shaft 2 in the circumferential direction, so that the reel 12 and the transmission shaft 2 inserted therein will not slide relative to each other in the circumferential direction, ensuring effective transmission of the transmission shaft 2.

In an embodiment, the internal thread 125 is directly integrally formed on the wall of the inner hole 121. The embodiment reduces the number of accessories required for the cord winding device 1 and lowers the assembly difficulty by integrating the internal thread 125 onto the wall of the inner hole 121.

In an embodiment, as shown in FIGS. 2-3, the base 10 is provided with end walls at both ends, and the axial movement stroke of the reel 12 is between the two end walls. The embodiment sets the corresponding end walls at the both ends of the base 10, where one end wall is used to define an initial position of the reel 12 when the carrying cord 3 is completely unwound, and the opposite end is used to assemble and connect the external threaded tube 14. The reel 12 moves from the initial position to the side of the external threaded tube 14 and winds the carrying cord 3 in turns until the carrying cord 3 is completely wound. Therefore, during the process of lifting or lowering the curtain body of the curtain, the reel 12 is always fully stored in the base 10, achieving effective shielding of the reel 12, avoiding interference from other external components of the base 10 on the operation of the reel 12, and ensuring smooth winding of the carrying cord 3.

In an embodiment, as shown in FIGS. 2-3, a positioning flange 143 is formed radially outward at the end of the external threaded tube 14 away from the reel 12. An anti-detachment hook 145 is formed at a side of the positioning flange 143. An insertion slot 101 is defined in the end wall of the corresponding end of the base 10, and a hook hole 103 is defined in a slot wall of the insertion slot 101, corresponding to the anti-detachment hook 145. After inserting the positioning flange 143 into the insertion slot 101, the anti-detachment hook 103 is hooked into the hook hole 103. The embodiment achieves a fixed connection between the external threaded tube 14 and the base 10 by radially protruding the positioning flange 143 at the end of the external threaded tube 14 away from the reel 12, and inserting the positioning flange 143 of the external threaded tube 14 into the corresponding insertion slot 101 in the end wall of the corresponding end of the base 10, and the structure is simple and the assembly is convenient. In addition, the anti-detachment hook 145 is formed at the side of the positioning flange 143, which is used to engage in the hook hole 103 opened in the slot wall of the insertion slot 101, thereby improving the stability of the connection between the external threaded tube 14 and the base 10.

In an embodiment, as shown in FIGS. 1-2, the cord winding device 1 further includes a cover 18 covered on a top of the base 10. Two ends of the cover 18 extend towards the base 10 with two first fasteners 181 and a contact block 183 corresponding to the insertion slot 101. The two end walls of the base 10 are provided with two second fasteners 105 that correspond one-to-one with the first fasteners 181. The cover 18 is fixed relative to the base 10 by hooking and cooperating with the first fasteners 181 and the second fasteners 105, and the positioning flange 143 is abutted against and fixed by the contact block 183. In the embodiment, by setting the cover 18 on the top of the base 10, it can correspondingly cover the reel 12 and the external threaded tube 14, avoiding foreign objects from falling into the base 10 and interfering with the winding of the carrying cord 3. The cover 18 is fixed relative to the base 10 by interlocking the first fasteners 181 at the both ends with the second fasteners 105 on the base 10, with a simple structure and easy assembly. The cover 18 is equipped with the contact block 183 corresponding to the insertion slot 101, and when the cover 18 is fastened and fixed, the contact block 183 is abutted against the top of the positioning flange 143, effectively fixing the positioning flange 143. In the specific implementation process, one of each first fastener 181 and the corresponding second fastener 105 may be a structure such as a locking protrusion or a locking hook, while the other is correspondingly set as a structure such as a hole or a locking slot.

The embodiments of the present invention have been described above with reference to the accompanying drawings, but the present invention is not limited to the specific implementations described above, and the specific implementations described above are only schematic and not limiting. Under the enlightenment of this invention, many forms can be made without departing from the scope of this invention and the scope of protection of the claims, and these are all included in the scope of protection of this invention.

What is claimed is:

1. A cord winding device of a curtain, comprising:
a base forming one end wall on at least one end;
a reel mounted to the base, wherein the reel defines an inner hole extending through the reel in an axis center of the reel, for a transmission shaft of the curtain extending through, a connection structure is provided in and at one end of the inner hole, which connects the reel and the transmission shaft in a relatively fixed manner in a circumferential direction and in a relatively movable manner in an axial direction; and
an external threaded tube fixed to the end wall of the base with one end, and coaxially arranged with the reel for the transmission shaft extending through an axial hole of the external threaded tube, wherein an internal thread is provided on the other end of the inner hole away from the connection structure, one end of the external threaded tube is inserted into the inner hole from the end of the inner hole with the internal thread and screwed correspondingly with the internal thread; wherein when the reel rotates with the transmission shaft, the reel moves axially relative to the external threaded tube by spiraling and keeps being always screwed to the external threaded tube.

2. The cord winding device of claim 1, wherein a nut with the internal thread is fixedly assembled inside the inner hole, and the external threaded tube is correspondingly screwed to the nut.

3. The cord winding device of claim 2, wherein a plurality of elastic positioning tabs extending along an axial direction is formed on an outer wall of the nut, and a distal end of each positioning tab is provided with an outwardly protruding positioning protrusion; a wall of the inner hole at the corresponding end defines a plurality of positioning holes, and the nut is inserted into the inner hole and positioned by the plurality of positioning protrusions engaging in the plurality of positioning holes.

4. The cord winding device of claim 3, wherein a plurality of guide slots extending along the axial direction is defined the outer wall of the nut, and a plurality of guide protrusions extending along the axial direction is protruded on the wall at the corresponding end of the inner hole; wherein when the nut is inserted into the inner hole, the plurality of guide protrusions is correspondingly inserted into the plurality of guide slots.

5. The cord winding device of claim 3, wherein a plurality of guide protrusions extending along the axial direction is formed on the outer wall of the nut, the wall of the inner hole defines a plurality of guide slots extending along the axial direction from a hole opening; wherein when the nut is inserted into the inner hole, the plurality of guide protrusions is correspondingly inserted into the plurality of guide slots.

6. The cord winding device of claim 1, wherein the connection structure is a plurality of protruded protrusions protruding from a wall of the inner hole and corresponding to a plurality of axial slots defined in an outer wall of the transmission shaft, or, the connection structure is a plurality of key slots defined in the wall of the inner hole, corresponding to a plurality of key bars axially extending on the outer wall of the transmission shaft.

7. The cord winding device of claim 1, wherein the internal thread is directly integrally formed on a wall of the inner hole.

8. The cord winding device of claim 1, wherein the base is provided with two end walls at both ends, and an axial movement stroke of the reel is between the two end walls.

9. The cord winding device of claim 8, wherein a positioning flange is formed radially outward at the end of the external threaded tube away from the reel, an anti-detachment hook is formed at a side of the positioning flange; an insertion slot is defined in the end wall of the corresponding end of the base, and a hook hole is defined in a slot wall of the insertion slot, corresponding to the anti-detachment hook; wherein after inserting the positioning flange into the insertion slot, the anti-detachment hook is hooked into the hook hole.

10. The cord winding device of claim 9, further comprising a cover covered on a top of the base, wherein two ends of the cover extend towards the base with two first fasteners, and a contact block corresponding to the insertion slot; the two end walls of the base are provided with two second fasteners that correspond one-to-one with the first fasteners, the cover is fixed relative to the base by hooking and cooperating with the first fasteners and the second fasteners, and the positioning flange is abutted against and fixed by the contact block.
